(19) United States
(12) Patent Application Publication
(10) Pub. No.: US 2004/0128138 A1
(43) Pub. Date: Jul. 1, 2004

(54) Universal type-in line

(76) Inventors: Donna B. Andrews, Shoreline, WA (US); David S. Koon, Seattle, WA (US); Gerard Neufeld-Kaiser, Seattle, WA (US); Christina Storm, Seattle, WA (US); Susan E. Dziadosz, Seattle, WA (US); Jenny T. Lam, Seattle, WA (US); David R. Parker, Kirkland, WA (US); John M. Tippett, Seattle, WA (US); Tjeerd Hoek, Kirkland, WA (US); Mark R. Ligameri, Everett, WA (US); Christopher T. Sager, Bellevue, WA (US); Kanwal VedBratzar, Seattle, WA (US); Gerald Paul Joyce, Woodinville, WA (US); Marc M. Miller, Seattle, WA (US); Tony E. Schreiner, Redmond, WA (US); Eric B. Watson, Redmond, WA (US); Adrian C. Klein, Seattle, WA (US); Vidya R. Nallathimmayyagari, Redmond, WA (US); Beverly H. Sobelman, Seattle, WA (US)

Correspondence Address: SHOOK, HARDY & BACON, 1200 MAIN STREET, ONE KANSAS CITY PLACE, KANSAS CITY,, MO, 64105-2118, US

(21) Appl. No.: 10/186,039

(22) Filed: Jun. 28, 2002

(51) Int. Cl. G06F 17/20

(52) U.S. Cl. 704/275

(57) ABSTRACT

The present invention provides a system and method for improving a user's ability to direct the computer to perform a desired function. A single uniform input control is provided that receives user input, such as from a keyboard. The present embodiment then parses the user input to determine its input type and whether the input type corresponds to a single, recognized action performable by the computer and, if so, performs the action. Such recognized actions include navigating to an Internet site and composing an e-mail message. If the input type does not correspond to a single recognized action, the user input is submitted to at least one text processor, such as a natural language processor, that analyzes the user input to obtain at least one interpretation corresponding to an action performable by the computer. The at least one interpretation is returned to the user who may select a desired action from among the listing of interpretations.

### CROSS-REFERENCE TO RELATED APPLICATIONS

Not Applicable.

### STATEMENT REGARDING FEDERALLY SPONSORED RESEARCH OR DEVELOPMENT

Not Applicable.

### TECHNICAL FIELD

The present invention relates to a computer system and, more particularly, to a system and method for enabling a computer to more effectively perform an action in response to natural language input from a user.

### BACKGROUND OF THE INVENTION

The history of personal computing has been strongly influenced by a desire to make personal computers easier to use. At an early period, personal computers were often the domain of the electronic hobbyist sufficiently skilled to understand binary or thereafter assembly language programming. The difficulty of these languages meant that a limited number of people could successfully use a personal computer.

The advent of faster microprocessors accelerated the demand for a more usable operating system. The MICROSOFT DISK OPERATING SYSTEM, or MS-DOS, product filled a need for a PC operating system with a more usable command set. In the MS-DOS product, commands using generally easily remembered abbreviations were provided allowing people to perform certain basic operations such as file management and printing.

A next important step forward was the development of a graphical user interface for the PC, such as the MICROSOFT WINDOWS operating system product. Graphical user interface windowing environments freed the user from having to remember a textual command and, instead, permitted the user to select commands graphically displayed on the computer monitor using a pointing device, such as a mouse. The exponential growth in popularity of the Internet also swelled the ranks of personal computer users. Many users can now use Internet browser software with little or no training.

The increase in speed and functionality of personal computers has led to the development of a multitude of computer capabilities that can at times overwhelm an average user. While users can be provided with a help file to answer questions, it may not provide the answer the user is looking for if the user selects a help file from a non-pertinent application. Often a user simply wants to know how to perform a particular task without having to first read instructions or a help file. For example, the user may want to navigate to an Internet site, send an email, search for information about a new car or erase a particular file from the computer. Presently, each of these operations would require the user to select a different starting point and pursue a different command sequence. For example, if the user wished to navigate to a particular web site, the user would have to know to enter an Internet site identifier, or Uniform Resource Locator, in the address control of an Internet browser. Similarly, if a user wanted to compose a new e-mail message, another software would have to be used. Additional software would have to be employed in order, for example, to erase a file, such as the MICROSOFT WINDOWS Explorer file navigator in the MICROSOFT WINDOWS product. At present, consumers can become frustrated when seeking the proper command or starting point to perform a desired function.

### BRIEF SUMMARY OF THE INVENTION

The present invention solves the problems of the existing software by providing users with a single on-screen data entry point for requesting a variety of actions in a form convenient to the user and processing such request to perform a desired action.

The present invention is carried out on a computer, such as one using the MICROSOFT WINDOWS operating system. The computer is supplied with software such as a browser or other software capable of receiving user input. The computer is further supplied with a parser, a client keyword cross-reference and at least one text processor adapted to receive the user input and to return at least one interpretation based on the user input corresponding to an action performable by the computer.

The embodiment receives user input from a user by means of an input control, such as the address control of a browser software. The user will normally provide natural language input by entering a request for a desired action into the address control using a keyboard.

The parser then parses the user input to determine an input type. The embodiment is well-suited to recognize a variety of input types using parsing methodologies known to those skilled in the art. In this regard, input types could include an Internet site identifier, such as a URL, a request to send an e-mail, a keyword referencing an action performable on the local computer or other action. If the input type corresponds to a single recognized command performable by the computer, the computer is directed to perform this command. Otherwise, the user input is submitted to at least one text processor, such as a natural language processor or an Internet search engine, to obtain at least one interpretation of the user's desired action that corresponds to an action performable by the computer. If the at least one interpretation is obtained, the at least one interpretation is then returned to the user.

If no interpretation is obtained, it is likely that the user input was invalid and no interpretation corresponding to an action performable by the computer may be returned. If the at least one interpretation is a single interpretation, the action corresponding thereto may be immediately performed. Otherwise, the interpretation may be combined into a single list of interpretations and displayed to the user, optionally sorted in order of relevance. The user may select an interpretation corresponding to the desired action, whereupon the computer is directed to perform the selected action.

### BRIEF DESCRIPTION OF THE SEVERAL VIEWS OF THE DRAWING

These and other objectives and advantages of the present invention will be more readily apparent from the following detailed description of the drawings of an embodiment of the invention herein incorporated by reference and in which:

FIG. 1 is an overview of a computer system capable of carrying out the present invention.

FIG. 2 is a screenshot illustration of an input control for receiving user input.

FIG. 3 is an overview of a methodology of the present invention.

FIG. 4 is a screenshot illustration of a portion of the present invention.

FIG. 5 is a screenshot illustration of a portion of the present invention.

FIG. 6 is a screenshot illustration of a portion of an electronic mail application.

FIG. 7 is a screenshot illustration of a portion of the present invention.

FIG. 8 is a screenshot illustration of a portion of the present invention.

### DETAILED DESCRIPTION OF THE INVENTION

The embodiment is directed to a universal type-in line, or input control, for receiving a wide variety of user requests for assistance and processing the information to obtain a relevant response to the user input. The embodiment provides users a single starting point and interface for entering requests, for example, to navigate to Internet sites, perform tasks on the local computer and search the web.

The present invention is carried out on a personal computer, such as one using the MICROSOFT WINDOWS operating system. The personal computer may be further supplied with software such as a browser or other software capable of receiving user input. The computer is further supplied with a parser programmed to accept the user input, parse the input and determine the input type from the parsed result. In this regard, input types include an Internet site identifier, such as a URL, a request to compose an e-mail message, a request to perform a command on the local computer or other request. The parser is programmed to determine whether the user input type corresponds to a single recognized action performable by the computer and, if so, to direct the computer to perform the action. The user input may be supplied in a variety of ways, such as by using the computer keyboard.

If, on the other hand, the user input type does not correspond to a single recognized action, then the user input is submitted to at least one text processor, such as a natural language processor, to obtain at least one interpretation corresponding to an action performable by the computer and, if the at least one interpretation is obtained, returns the at least one interpretation to the user. If no interpretation can be obtained, it is likely that the user input was invalid and, thus no interpretation corresponding to an action performable by the computer may be maintained. In returning the at least one interpretation to the user, the present invention may direct the computer to perform the action corresponding to the at least one interpretation if the at least one interpretation is comprised of but a single interpretation. If the at least one interpretation on the other hand, is comprised of more than a single interpretation, the present invention merges the interpretations into a single list of interpretations displayed to the user who thereupon may select an interpretation to be performed.

Having briefly described the embodiment of the present invention, an exemplary operating system for the present invention is described below.

### Exemplary Operating Environment

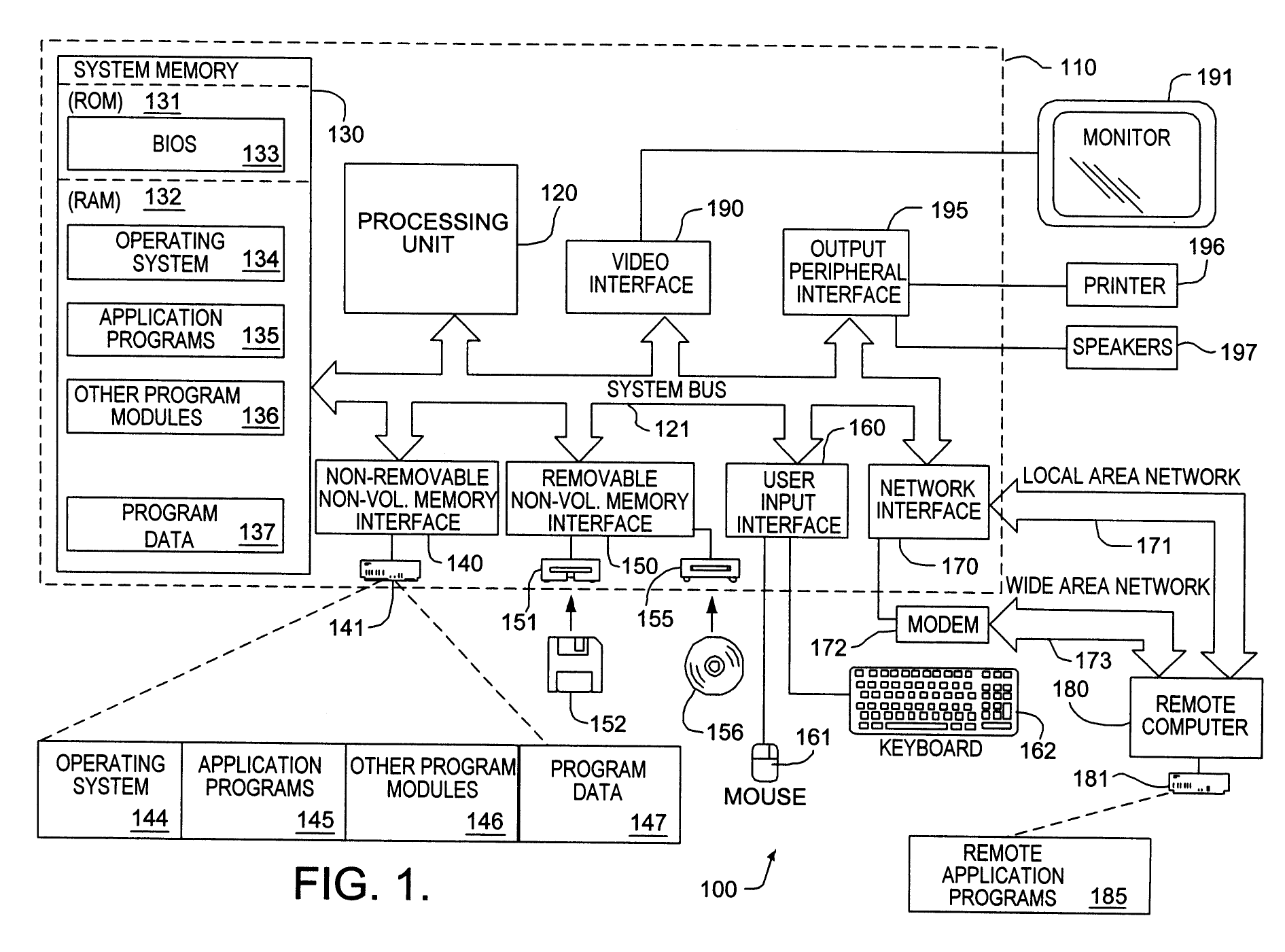

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system 100 for implementing the invention includes a general purpose computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

### Universal Type-in Line

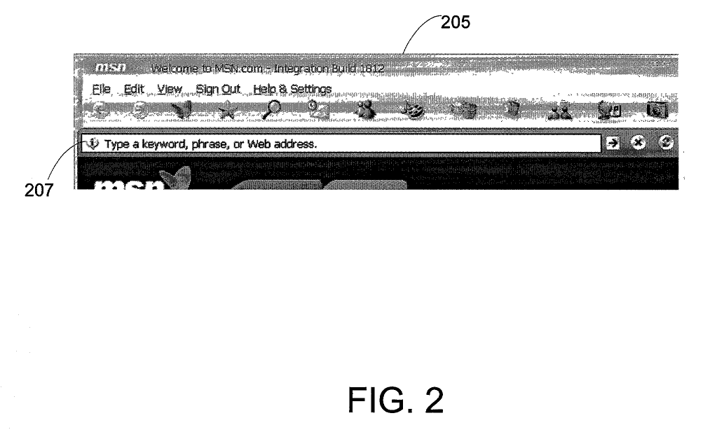

The universal type-in line of the embodiment may be implemented in a number of ways. FIG. 2 shows an example of the universal type-in line in the context of an Internet browser 205 having an address control 207 configured in accordance with the embodiment to receive natural language user input. For the convenience of the user, address control 207 may display an initial prompting text communicating to the user what and where requests may be entered. Such text could include, as shown in FIG. 2, “Type a keyword, phrase or web address.”

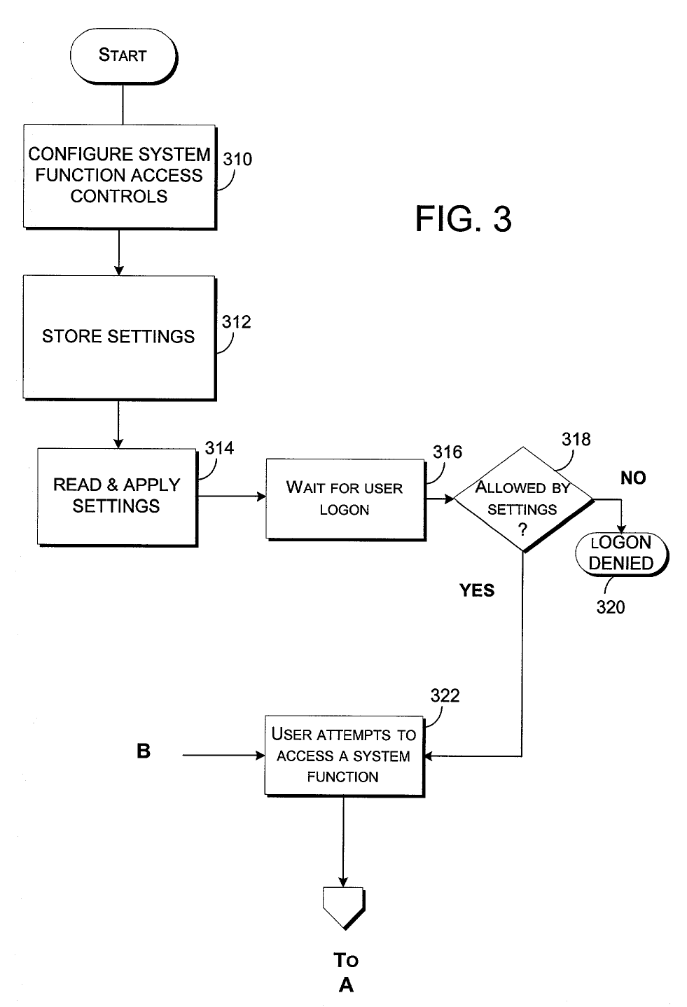

FIG. 3 illustrates the methodology of the embodiment. As will be understood by those skilled in the art, the embodiment could be implemented in a number of ways, such as by modifying the source code of browser software and providing the computer with software components discussed below. The method of the present embodiment begins by receiving user input at step 210. The user input will likely be in a natural language form, such as a sentence or sentence fragment. Moreover, the natural language user input is received by an input control, such as the address control of an Internet browser. The user input is communicated to a parser and, at step 212, the user input is parsed to determine the input type. As will be understood by those skilled in the art, the parsing operation could be carried out in a number of ways. The objective of the parsing operation is to determine whether the user input corresponds to a single recognized action. In this regard, as will be appreciated by those skilled in the art, a number of methodologies could be employed to determine whether the user input does correspond to the single recognized action, such as, determining whether the user input is a Internet site identifier, such as a URL, an e-mail address or otherwise contains a keyword suggesting the user is attempting to execute a command on the local computer.

As will be understood by those skilled in the art, Internet site identifiers, or URLs, primarily are either a domain name reference, such as www.xyz.com, or an IP address in the form nnn.nnn.nnn.nnn, where “nnn” indicates a numerical value. The parser thus determines whether the user input matches one of these patterns and, if so, directs the computer to navigate to the Internet site referenced by the site identifier. A similar approach can be employed to determine whether an e-mail address has been entered into the input control whereupon the computer could be directed to execute an electronic mail application. To facilitate recognition of a local command, the local computer is supplied with a client keyword cross-reference wherein each keyword in the client keyword cross-reference is associated with an action performable by the computer. The client keyword cross-reference may be supplied in a variety of ways, such as in the form of an Extensible Markup Language (“XML”) document. For example, the client keyword cross-reference might contain the keyword “e-mail” and associate the keyword with the action of executing an electronic mail application. The client keyword cross-reference may further contain keywords that are interpreted differently depending upon the application being executed. In this way, the client keyword cross-reference enables the embodiment to select an action on the local computer that is relevant to the application executing on the computer. The parser then determines whether the user input contains a word in the client keyword cross-reference and, if so, directs the computer to perform the action associated with the keyword.

In each of these examples, the parser has identified a single recognized action. If at step 214 the single recognized action has been identified, then at step 216 the computer is directed to perform the action. In this regard, for example, if the user input were “john@xyz.com” the action performed at step 216 could be to direct the computer to execute an electronic mail application so that the user could compose a new e-mail message.

If, on the other hand, at step 214, a recognized action has not yet been identified, control passes to a submitter at step 218 which is in communication with at least one text processor. The submitted determines whether the user input should be submitted to a further natural language processor and/or submitted to an Internet search engine. The submitter could be implemented in a number of ways, such as by performing a brief natural language processing methodology on the user input to determine the type of text processor(s) best suited to process the user input and return a usable interpretation. The submitter then submits the user input to at least one text processor, illustrated in FIG. 2 at steps 220, 222 and 224. The number of text processors shown in FIG. 2 is merely illustrative. Fewer and more text processors are contemplated by the embodiment.

As shown in FIG. 2, text processor 220 is a natural language processor, which is known to those skilled in the art, capable of receiving the user input and producing at least one interpretation. Text processor 222 could be a remote server service, such as the Microsoft Search Companion service, that could perform additional natural language processing on the user input to produce interpretations for the user's consideration. Text processor 224 could be an Internet search engine, such as the MSN Search Internet search engine. In addition, the text processor may be configured to call back into the embodiment with a query or a tokenized form of the user input to obtain additional information used to produce interpretations. In this way, the text processors enable the embodiment to select an action that is relevant to the application executing on the computer.

The text processor returns at least one interpretation if one is available, but it is possible that no interpretations would be returned. Instances in which no interpretation would be returnable could include instances where the user input is invalid. Upon receiving the at least one interpretation from the at least one text processor, the embodiment merges the interpretations at step 226 into a single list of selectable interpretations. During the merge process, interpretations may be discarded if they do not apply within the current context. For example, if the user input were “send message,” an interpretation might be to create a new e-mail message but could also be to send the current e-mail message. If the user is not currently editing an e-mail message, the latter interpretation could be discarded and not displayed to the user. Control then passes to step 228 to determine whether the embodiment has returned a single interpretation and, if so, control passes to step 234 to return the at least one interpretation to the user by directing the computer to perform the action corresponding to the single interpretation and, in this way, returning the at least one interpretation to the user.

If, on the other hand, the at least one interpretations includes multiple interpretations, control passes to step 232 whereupon the interpretations are returned to the user by displaying them to the user and allowing the user to select one of the interpretations. In addition, the interpretations shown to the user in a single list of selectable interpretations may be sorted in order of relevance as determined by the text processors. In this regard, the text processors, as will be appreciated by those skilled in the art, are capable of assigning a relevance rating to the particular interpretation, which is used in the embodiment. Control then passes to step 234 to direct the computer to perform the action chosen by the user whereupon the present invention may respond by seeking additional input from the user to eliminate any ambiguity in the user's request.

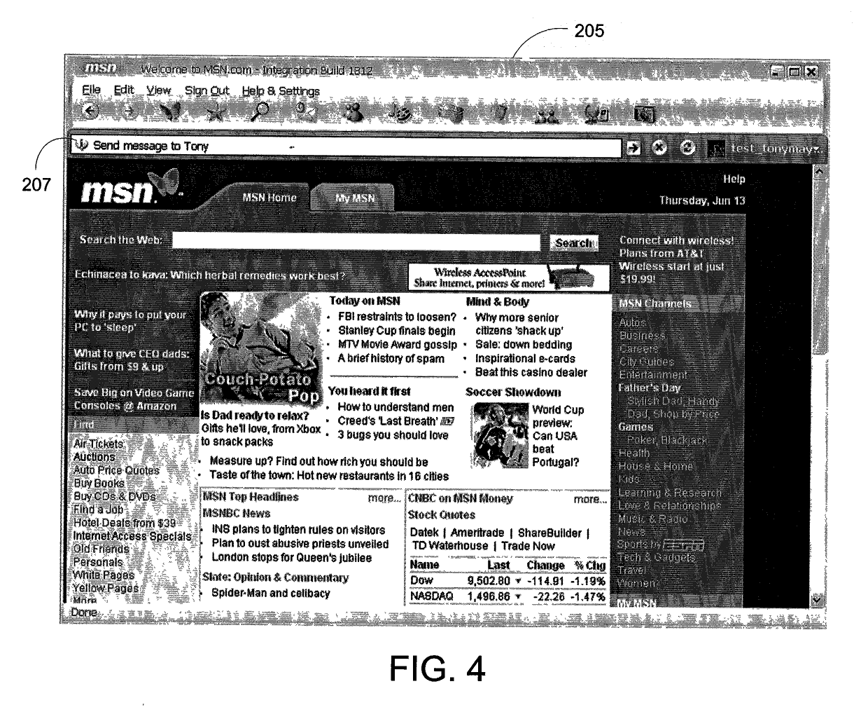

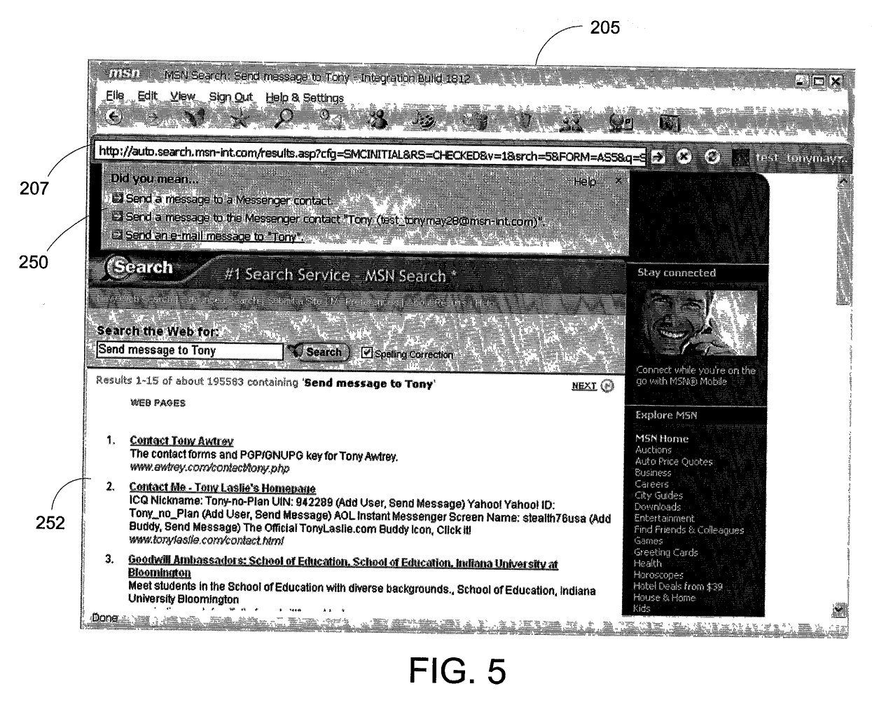

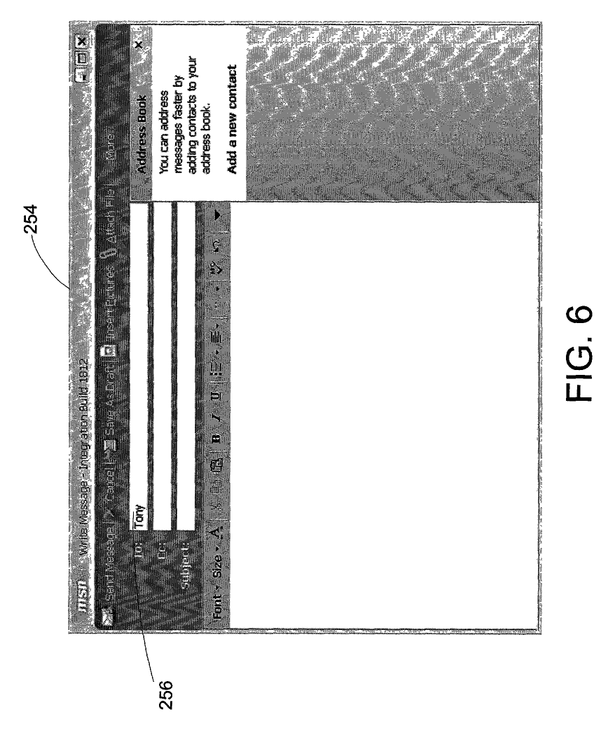

In operation, as shown in FIG. 4, an internet browser 205 contains an address control 207 into which user has submitted the natural language user input “send message to Tony.” The present invention parses the user input to determine for the user input an input type. In this example, the user input does not correspond to a single recognized action performed by a computer because it is not an internet site identifier, it does not unambiguously seek to send an e-mail and it does not reference a keyword on the keyword cross-reference. Thus, the user input “send message to Tony” is submitted to at least one text processor that analyzes the user input to produce, as shown in FIG. 5, at least one interpretation corresponding to an action performable by the computer and thereby returning the at least one interpretation to the user. In this regard, the single list of selectable interpretations 250 is provided to the user as are the Internet search results 252, which in this case are also an interpretation. In this instance, the user is shown in FIG. 5 as choosing the selectable interpretation “send an e-mail message to ‘Tony.’” Thereupon, as shown in FIG. 6, an e-mail application 254 is executed thereby enabling the user to send an e-mail message to Tony whose address information has been submitted to control 256.

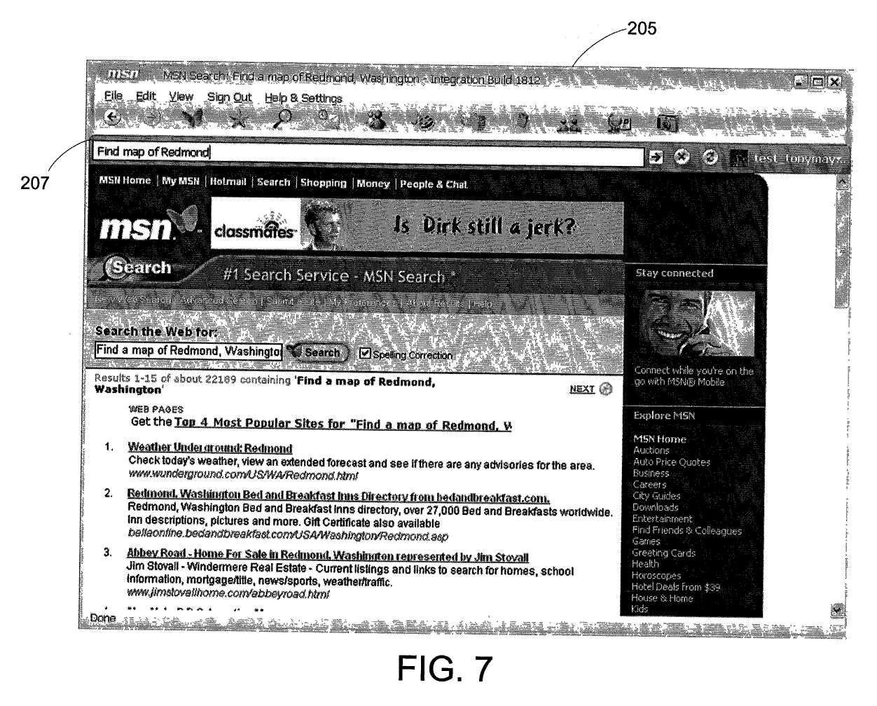

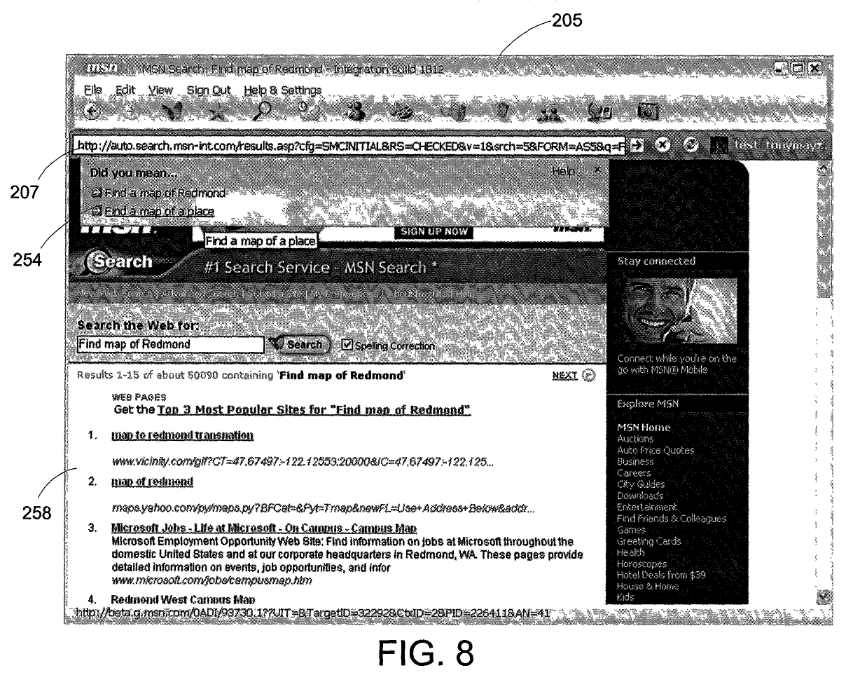

Another example of the present invention in operation is shown in FIG. 7. Internet browser 205 has address control 207. A user supplies the natural language user input “find map of Redmond” into address control 207. Thereupon the user input is parsed to determine for the user input an input type. In this example, the input type does not correspond to a single recognized action performed by the computer, the user input is submitted to at least one text processor that analyzes the user input to produce at least one interpretation corresponding to an action performable by the computer and thereafter as shown in FIG. 8 returns the at least one interpretation to the user. The single list of selectable interpretations 254 thus enables the user to select a desired action. In addition, the user input may be submitted to an Internet search engine text processor and the Internet search results 258, herein considered as an interpretation, may be displayed to the user.

From the foregoing, the invention can be seen to provide a consumer with a valuable way to better utilize a personal computer. By enabling consumers to input desired actions in a variety of ways at a single location, consumers are spared many of the problems in attempting to locate the correct starting point for the command. The various computer systems and components shown in FIGS. 1-8 and described in the specification are merely exemplary of those suitable for use in connection with the present invention. For example, other embodiments are contemplated hereby, such as using a variety of text processors. Accordingly, the scope of the present invention is defined by the appended claims rather than the foregoing description.

We claim:

1. A method for directing a computer including at least one text processor to perform an action in response to natural language user input, comprising:
receiving the user input from a user;
parsing the user input to determine for the user input an input type;
determining whether the input type corresponds to a single recognized action performable by the computer and, if so, directing the computer to perform the action; and
submitting, if the user input type does not correspond to a single recognized action, the user input to the at least one text processor to obtain at least one interpretation corresponding to an action performable by the computer and, if the at least one interpretation is obtained, returning the at least one interpretation to the user.

2. The method of claim 1, wherein the step of returning the at least one interpretation includes displaying to the user the at least one interpretation when the at least one interpretation comprises more than a single interpretation.

3. The method of claim 2, further comprising receiving from the user a selected interpretation chosen from the at least one interpretation and directing the computer to perform the action corresponding to the selected interpretation.

4 The method of claim 1, wherein the step of returning the at least one interpretation further includes directing the computer to perform, if the at least one interpretation comprises a single interpretation, the action corresponding to the at least one interpretation.

5. The method of claim 1, wherein the step of returning the at least one interpretation further includes:
merging the at least one interpretation into a single list of selectable interpretations; and
displaying the single list of selectable interpretations to the user.

6. The method of claim 5, wherein the single list of selectable interpretations is sorted in order of relevance.

7. The method of claim 5, further comprising deleting interpretations that are not relevant to the user's context from the single list of selectable interpretations.

8. The method of claim 5, further comprising receiving from the user a selected interpretation chosen from the single list of selected interpretations and directing the computer to perform the action corresponding to the selected interpretation.

9. The method of claim 1, wherein the natural language user input is received by an input control associated with the computer.

10. The method of claim 1, wherein the natural language user input is received from a keyboard device.

11. The method of claim 1, wherein the step of receiving the user input includes receiving the user input by an address control of a browser executing on the computer.

12. The method for claim 1, wherein the step of determining whether the input type corresponds to a single recognized action further includes determining whether the user input is an Internet site identifier and, if so, directing the computer to access the Internet site referenced by the site identifier.

13. The method for claim 1, wherein the step of determining whether the input type corresponds to a single recognized action further includes determining whether the user input is a request to compose an electronic mail message and, if so, directing the computer to execute an electronic mail application.

14. The method for claim 1, wherein the step of determining whether the input type corresponds to a recognized action further includes:
accessing a client keyword cross-reference, wherein each keyword in the client keyword cross-reference is associated with an action performable by the computer; and
determining whether the user input contains a word in the client keyword cross-reference, and, if so, directing the computer to perform the action associated with the keyword.

15. The method of claim 1, wherein the at least one text processor includes a natural language processor.

16. The method of claim 1, wherein the at least one text processor includes an Internet web search engine.

17. A method for directing a computer executing an application and comprising at least one text processor to perform an action in response to natural language user input, comprising:
receiving the user input from a user;
parsing the user input to determine for the user input an input type;
determining whether the input type corresponds to a single recognized action performable by the computer and relevant to the application and, if so, directing the computer to perform the action; and
submitting, if the user input type does not correspond to a single recognized action, the user input to the at least one text processor to obtain at least one interpretation corresponding to an action performable by the computer and relevant to the application and, if the at least one interpretation is obtained, returning the at least one interpretation to the user.

18. The method of claim 17, wherein the step of returning the at least one interpretation includes displaying to the user the at least one interpretation when the at least one interpretation comprises more than a single interpretation.

19. The method of claim 17, further comprising receiving from the user a selected interpretation chosen from the at least one interpretation and directing the computer to perform the action corresponding to the selected interpretation.

20. The method of claim 17, wherein the step of returning the at least one interpretation further includes directing the computer to perform, if the at least one interpretation comprises a single interpretation, the action corresponding to the at least one interpretation.

21. The method of claim 17, wherein the step of returning the at least one interpretation further includes:
merging the at least one interpretation into a single list of selectable interpretations; and
displaying the single list of selectable interpretations to the user.

22. The method of claim 21, wherein the single list of selectable interpretations is sorted in order of relevance.

23. The method of claim 21, further comprising deleting interpretations that are not relevant to the user's context from the single list of selectable interpretations.

24. The method of claim 17, further comprising receiving from the user a selected interpretation chosen from the single list of selected interpretations and directing the computer to perform the action corresponding to the selected interpretation.

25. The method of claim 17, wherein the natural language user input is received by an input control associated with the computer.

26. The method of claim 17, wherein the natural language user input is received from a keyboard device.

27. The method of claim 17, wherein the step of receiving the user input includes receiving the user input by an address control of a browser executing on the computer.

28. The method for claim 17, wherein the step of determining whether the input type corresponds to a recognized action further includes determining whether the user input is an Internet site identifier and, if so, directing the computer to access the Internet site referenced by the site identifier.

29. The method for claim 17, wherein the step of determining whether the input type corresponds to a recognized action further includes determining whether the user input is a request to compose an electronic mail message and, if so, directing the computer to execute an electronic mail application.

30. The method for claim 17, wherein the step of determining whether the input type corresponds to a recognized action further includes:
accessing a client keyword cross-reference, wherein each keyword in the client keyword cross-reference is associated with an action performable by the computer; and
determining whether the user input contains a word in the client keyword cross-reference, and, if so, directing the computer to perform the action associated with the keyword.

31. The method of claim 17, wherein the at least one text processor includes a natural language processor.

32. The method of claim 17, wherein the at least one text processor includes an Internet web search engine.

33. A computer-readable medium having computer-executable instructions for performing a method for directing a computer comprising at least one text processor to perform an action in response to natural language user input, the method comprising:
receiving the user input from a user;
parsing the user input to determine for the user input an input type;
determining whether the input type corresponds to a single recognized action performable by the computer and, if so, directing the computer to perform the action; and
submitting, if the user input type does not correspond to a single recognized action, the user input to the at least one text processor to obtain at least one interpretation corresponding to an action performable by the computer and, if the at least one interpretation is obtained, returning the at least one interpretation to the user.

34. The computer-readable medium of claim 33, wherein the step of returning the at least one interpretation includes displaying to the user the at least one interpretation when the at least one interpretation comprises more than a single interpretation.

35. The computer-readable medium of claim 34, further comprising receiving from the user a selected interpretation chosen from the at least one interpretation and directing the computer to perform the action corresponding to the selected interpretation.

36. The computer-readable medium of claim 33, wherein the step of returning the at least one interpretation further includes directing the computer to perform, if the at least one interpretation comprises a single interpretation, the action corresponding to the at least one interpretation.

37. The computer-readable medium of claim 33, wherein the step of returning the at least one interpretation further includes:
merging the at least one interpretation into a single list of selectable interpretations; and
displaying the single list of selectable interpretations to the user.

38. The computer-readable medium of claim 37, wherein the single list of selectable interpretations is sorted in order of relevance.

39. The method of claim 37, further comprising deleting interpretations that are not relevant to the user's context from the single list of selectable interpretations .

40. The computer-readable medium of claim 37, further comprising receiving from the user a selected interpretation chosen from the single list of selected interpretations and directing the computer to perform the action corresponding to the selected interpretation.

41. The computer-readable medium of claim 33, wherein the natural language user input is received by an input control associated with the computer.

42. The computer-readable medium of claim 33, wherein the natural language user input is received from a keyboard device.

43. The computer-readable medium of claim 33, wherein the step of receiving the user input includes receiving the user input by an address control of a browser executing on the computer.

44. The computer-readable medium of claim 33, wherein the step of determining whether the input type corresponds to a single recognized action further includes determining whether the user input is an Internet site identifier and, if so, directing the computer to access the Internet site referenced by the site identifier.

45. The computer-readable medium of claim 33, wherein the step of determining whether the input type corresponds to a single recognized action further includes determining whether the user input is a request to compose an electronic mail message and, if so, directing the computer to execute an electronic mail application.

46. The computer-readable medium of claim 33, wherein the step of determining whether the input type corresponds to a recognized action further includes:
accessing a client keyword cross-reference, wherein each keyword in the client keyword cross-reference is associated with an action performable by the computer; and
determining whether the user input contains a word in the client keyword cross-reference, and, if so, directing the computer to perform the action associated with the keyword.

47. The computer-readable medium of claim 33, wherein the at least one text processor includes a natural language processor.

48. The computer-readable medium of claim 33, wherein the at least one text processor includes an Internet web search engine.

49. A computer-readable medium containing computer-executable instructions for performing a method for directing a computer executing an application and comprising at least one text processor to perform an action in response to natural language user input, the method comprising:
receiving the user input from a user;
parsing the user input to determine for the user input an input type;
determining whether the input type corresponds to a single recognized action performable by the computer and relevant to the application and, if so, directing the computer to perform the action; and
submitting, if the user input type does not correspond to a single recognized action, the user input to the at least one text processor to obtain at least one interpretation corresponding to an action performable by the computer and relevant to the application and, if the at least one interpretation is obtained, returning the at least one interpretation to the user.

50. The computer-readable medium of claim 49, wherein the step of returning the at least one interpretation includes displaying to the user the at least one interpretation when the at least one interpretation comprises more than a single interpretation.

51. The computer-readable medium of claim 49, further comprising receiving from the user a selected interpretation chosen from the at least one interpretation and directing the computer to perform the action corresponding to the selected interpretation.

52. The computer-readable medium of claim 49, wherein the step of returning the at least one interpretation further includes directing the computer to perform, if the at least one interpretation comprises a single interpretation, the action corresponding to the at least one interpretation.

53. The computer-readable medium of claim 49, wherein the step of returning the at least one interpretation further includes:
merging the at least one interpretation into a single list of selectable interpretations; and
displaying the single list of selectable interpretations to the user.

54. The computer-readable medium of claim 53, wherein the single list of selectable interpretations is sorted in order of relevance.

55. The method of claim 53, further comprising deleting interpretations that are not relevant to the user's context from the single list of selectable interpretations.

56. The computer-readable medium of claim 49, further comprising receiving from the user a selected interpretation chosen from the single list of selected interpretations and directing the computer to perform the action corresponding to the selected interpretation.

57. The computer-readable medium of claim 49, wherein the natural language user input is received by an input control associated with the computer.

58. The computer-readable medium of claim 49, wherein the natural language user input is received from a keyboard device.

59. The computer-readable medium of claim 49, wherein the step of receiving the user input includes receiving the user input by an address control of a browser executing on the computer.

60. The computer-readable medium of claim 49, wherein the step of determining whether the input type corresponds to a recognized action further includes determining whether the user input is an Internet site identifier and, if so, directing the computer to access the Internet site referenced by the site identifier.

61. The computer-readable medium of claim 49, wherein the step of determining whether the input type corresponds to a recognized action further includes determining whether the user input is a request to compose an electronic mail message and, if so, directing the computer to execute an electronic mail application.

62. The computer-readable medium of claim 49, wherein the step of determining whether the input type corresponds to a recognized action further includes:
accessing a client keyword cross-reference, wherein each keyword in the client keyword cross-reference is associated with an action performable by the computer; and
determining whether the user input contains a word in the client keyword cross-reference, and, if so, directing the computer to perform the action associated with the keyword.

63. The computer-readable medium of claim 49, wherein the at least one text processor includes a natural language processor.

64. The computer-readable medium of claim 49, wherein the at least one text processor includes an Internet web search engine.

65. A computer-readable medium having computer-executable instructions for directing a computer comprising at least one text processor to perform an action in response to natural language user input, comprising:
means for receiving the user input from a user;
means for parsing the user input to determine for the user input an input type;
means for determining whether the input type corresponds to a single recognized action performable by the computer and, if so, means for directing the computer to perform the action; and
means submitting, if the user input type does not correspond to a single recognized action, the user input to the at least one text processor to obtain at least one interpretation corresponding to an action performable by the computer; and
means for returning the at least one interpretation to the user.

66. The computer-readable medium of claim 65, wherein the means for returning the at least one interpretation includes means for displaying to the user the at least one interpretation when the at least one interpretation comprises more than a single interpretation.

67. The computer-readable medium of claim 66, further comprising means for receiving from the user a selected interpretation chosen from the at least one interpretation and means for directing the computer to perform the action corresponding to the selected interpretation.

68. The computer-readable medium of claim 65, wherein the means for returning the at least one interpretation further includes, if the at least one interpretation comprises a single interpretation, means for directing the computer to perform the action corresponding to the at least one interpretation.

69. The computer-readable medium of claim 65, wherein the means for returning the at least one interpretation further includes:
means for merging the at least one interpretation into a single list of selectable interpretations; and
means for displaying the single list of selectable interpretations to the user.

70. The computer-readable medium of claim 69, wherein the single list of selectable interpretations is sorted in order of relevance.

71. The method of claim 69, further comprising deleting interpretations that are not relevant to the user's context from the single list of selectable interpretations.

72. The computer-readable medium of claim 69, further comprising means for receiving from the user a selected interpretation chosen from the single list of selected interpretations and means for directing the computer to perform the action corresponding to the selected interpretation.

73. The computer-readable medium of claim 65, wherein the natural language user input is received by an input control associated with the computer.

74. The computer-readable medium of claim 65, wherein the natural language user input is received from a keyboard device.

75. The computer-readable medium of claim 65, wherein the means for receiving the user input includes means for receiving the user input by an address control of a browser executing on the computer.

76. The computer-readable medium of claim 65, wherein the means for determining whether the input type corresponds to a single recognized action further includes means for determining whether the user input is an Internet site identifier and, if so, for directing the computer to access the Internet site referenced by the site identifier.

77. The computer-readable medium of claim 65, wherein the means for determining whether the input type corresponds to a single recognized action further includes means for determining whether the user input is a request to compose an electronic mail message and, if so, for directing the computer to execute an electronic mail application.

78. The computer-readable medium of claim 65, wherein the means for determining whether the input type corresponds to a recognized action further includes:
means for accessing a client keyword cross-reference, wherein each keyword in the client keyword cross-reference is associated with an action performable by the computer; and
means for determining whether the user input contains a word in the client keyword cross-reference, and, if so, for directing the computer to perform the action associated with the keyword.

79. The computer-readable medium of claim 65, wherein the at least one text processor includes a natural language processor.

80. The computer-readable medium of claim 65, wherein the at least one text processor includes an Internet web search engine.

81. A computer-readable medium containing computer-executable instructions for directing a computer executing an application and having at least one text processor to perform an action in response to natural language user input, comprising:
means for receiving the user input from a user;
means for parsing the user input to determine for the user input an input type;
means for determining whether the input type corresponds to a single recognized action performable by the computer and relevant to the application and, if so, for directing the computer to perform the action; and
means for submitting, if the user input type does not correspond to a single recognized action, the user input to the at least one text processor to obtain at least one interpretation corresponding to an action performable by the computer and relevant to the application and, if the at least one interpretation is obtained, returning the at least one interpretation to the user; and
means for returning the at least one interpretation to the user.

82. The computer-readable medium of claim 81, wherein said means for returning the at least one interpretation includes means for displaying to the user the at least one interpretation when the at least one interpretation comprises more than a single interpretation.

83. The computer-readable medium of claim 81, further comprising means for receiving from the user a selected interpretation chosen from the at least one interpretation and for directing the computer to perform the action corresponding to the selected interpretation.

84. The computer-readable medium of claim 81, wherein said means for returning the at least one interpretation further includes, if the at least one interpretation comprises a single interpretation, for directing the computer to perform the action corresponding to the at least one interpretation.

85. The computer-readable medium of claim 81, wherein said means for returning the at least one interpretation further includes:
means for merging the at least one interpretation into a single list of selectable interpretations; and
means for displaying the single list of selectable interpretations to the user.

86. The computer-readable medium of claim 85, wherein the single list of selectable interpretations is sorted in order of relevance.

87. The method of claim 85, further comprising deleting interpretations that are not relevant to the user's context from the single list of selectable interpretations .

88. The computer-readable medium of claim 81, further comprising means for receiving from the user a selected interpretation chosen from the single list of selected interpretations and for directing the computer to perform the action corresponding to the selected interpretation.

89. The computer-readable medium of claim 81, wherein the natural language user input is received by an input control associated with the computer.

90. The computer-readable medium of claim 81, wherein the natural language user input is received from a keyboard device.

91. The computer-readable medium of claim 81, wherein said means for receiving the user input includes means for receiving the user input by an address control of a browser executing on the computer.

92. The computer-readable medium of claim 81, wherein said means for determining whether the input type corresponds to a recognized action further includes means for determining whether the user input is an Internet site identifier and, if so, for directing the computer to access the Internet site referenced by the site identifier.

93. The computer-readable medium of claim 81, wherein said means for determining whether the input type corresponds to a recognized action further includes means for determining whether the user input is a request to compose an electronic mail message and, if so, for directing a computer to execute an electronic mail application.

94. The computer-readable medium of claim 81, wherein said means for determining whether the input type corresponds to a recognized action further includes:
means for accessing a client keyword cross-reference, wherein each keyword in the client keyword cross-reference is associated with an action performable by the computer; and
means for determining whether the user input contains a word in the client keyword cross-reference, and, if so, for directing the computer to perform the action associated with the keyword.

95. The computer-readable medium of claim 81, wherein the at least one text processor includes a natural language processor.

96. The computer-readable medium of claim 81, wherein the at least one text processor includes an Internet web search engine.

97. A system for directing a computer to perform a task in response to natural language user input, comprising:
an input control associated with the computer that receives natural language user input from an input device coupled with the computer;
a parser that parses said user input to determine for the user input an input type, determines whether the input type corresponds to a single recognized action performable by the computer and, if so, directs the computer to perform the action; and
at least one text processor that analyzes said user input at least when it does not correspond to a single recognized action to produce at least one interpretation corresponding to an action performable by the computer and communicates with a display control to return the at least one interpretation to the user.

98. The system of claim 97, further including a client keyword cross-reference in communication with said parser, wherein each keyword in said keyword cross-reference is associated with a command directing the computer to perform an action.
